(19) United States
(12) Patent Application Publication
(10) Pub. No.: US 2002/0089995 A1
(43) Pub. Date: Jul. 11, 2002

(54) Method for transmitting multiple downstream CATV channels using a single upconverter

(76) Inventors: Ofir Shalvi, Herzlia (IL); Mati Amit, Zur-Yigal (IL); Mordechai Segal, Herzlia (IL)

Correspondence Address: J. Dennis Moore, Texas Instruments Incorporated, M/S 3999, P.O. Box 655474, Dallas, TX, 75265, US

(21) Appl. No.: 09/755,970

(22) Filed: Jan. 5, 2001

(51) Int. Cl. H04N 7/173; H04N 7/16; H04L 12/28

(52) U.S. Cl. 370/431; 725/148

(57) ABSTRACT

A method and device (100, 200) for combining digital data signals, converting them to analog data signals, and transmitting the analog signals downstream via a single up converter (170, 270). The data transmission method includes generating a plurality of digital signals, digitally combining the digital signals, and converting the combined digital signal to an analog signal. The analog signal is up converted to a transmittable analog signal having a frequency suited for transmission along a particular transmission medium, and the transmittable analog signal is transmitted. The data transmission device (100, 200) includes a digital combiner circuit (180, 182, 282), a D/A converter (150, 152, 250), an up converter (170, 270), and an optional analog combiner circuit (190).

### TECHNICAL FIELD

This invention relates generally to data transmission, and more particularly to data transmission via an up converter.

### BACKGROUND OF THE INVENTION

Coaxial cables are often wired to homes to provide cable TV service and more recently, provide Internet access to people in the home. FIG. 1 shows a block diagram of a home 11 receiving video service from a cable TV service provider head end 30 and receiving Internet service from a head end 12 of a cable modem termination system (CMTS).

Cable TV service typically involves sending video signals in a downstream direction from a cable TV service provider 30, for example in a Moving Picture Experts Group (MPEG) format. MPEG is a family of standards used for coding audio-visual information (e.g., movies, video, music) in a digital compressed format, and is used for video-on-demand, for example. A transmitter or modulator 32 adapted to transmit MPEG signals is coupled to an up converter 34 as shown, at the Cable TV service provider head end 30 or central office. These MPEG signals are transmittable over a cable interface 31 to a set-top box 36 or digital television (DTV) 38 tuner. The set-top box 36 converts the MPEG video stream and converts it to the TV 39 standard. People in the home are then able to watch the video signal transmitted to the home 11 on the TV 39 or digital TV 38. Most set-top boxes 36 receive video signals only in a downstream direction, although some set-top boxes 36 are also equipped to transmit signals in an upstream direction, for ordering pay-per-view (PPV), for example.

Cable modems are being deployed today that allow high-speed Internet access in the home over a cable network, often referred to as a hybrid fiber coax (HFC) cable network. The architecture of a typical cable modem used in a cable network is shown in FIG. 1. A cable modem 10 is a unit that is installed in the consumer premise equipment (CPE) that may comprise a personal computer (PC) or other computing device, for example. The cable modem 10 is adapted to communicate with the cable modem termination system (CMTS) that is typically located at a cable network provider's headend 12. The cable modem 10 is a modulator/demodulator that receives Internet traffic or information from a server through the headend 12 and puts it into a format recognizable by a user's PC 13, allowing a user to browse the Internet and send/receive e-mail just as they would with a conventional modem on a PC. Using a cable modem 10 over a cable network provides a much faster connection, being at least 50 times faster than a 56K modem, for example.

Cable modem 10 performs the modulation and demodulation and the operations necessary to interface with a user's PC. A cable modem 10 typically comprises a transmitter 14 for upstream modulation of a signal, usually comprised of short bursts, that is transmitted to a receiver 16 in the headend 12 that serves as an upstream demodulator. The upstream signal may comprise webpage selection or search information, for example, and may be a QPSK/16-QAM at 3 Mbit/s. The cable modem 10 also comprises a receiver 18 for downstream demodulation of signals received from a transmitter 20 in the headend 12 that serves as a downstream modulator. The downstream modulation/demodulation may be 64-QAM/256 QAM at 27-56 Mbit/s, for example. Both the cable modem 10 and headend 12 include MACs 22, 24 that control the media access control (MAC) sublayer of the communication network. A standard for communicating data over cable is the Data Over Cable Service Interface Specification (DOCSIS).

The capacity requirement for downstream delivery of MPEG video signals is currently higher than for the upstream direction because there are many more subscribers signed up for video service than for bi-directional cable modem service, for example. What is needed in the art is a headend capable of more efficiently sending downstream signals to subscribers.

### SUMMARY OF THE INVENTION

The present invention achieves technical advantages as a data transmission method and device requiring fewer D/A converters, filters, and up converters than those of the prior art. Modulators for adjacent channels data signals share D/A converters, resulting in fewer D/A converters, filters, and up converters required in the headend. A single up converter may be used rather than up to a hundred, as in past headend designs.

Disclosed is a method of data transmission, comprising generating a plurality of first digital signals, digitally combining at least two of the first digital signals to create a first combined digital signal, and converting the first combined digital signal to a first analog signal. The central frequency of the first analog signal is shifted to create a transmittable analog signal having a frequency suited for transmission along a desired transmission medium.

Also disclosed is a data transmission device, comprising a first digital combiner circuit adapted to combine a plurality of digital data signals and create a first combined digital data signal, a first digital-to-analog converter (DAC) having an input coupled to the combined digital output of the first digital combiner circuit. The first DAC is adapted to convert the first combined digital data signal to a first analog data signal. The device includes an up converter coupled to the first DAC analog output adapted to up convert the first analog data signal in preparation for transmission.

Further disclosed is a data transmission device, comprising a first digital combiner circuit adapted to combine a plurality of digital data signals and create a first combined digital data signal, and a first digital-to-analog converter (DAC) having an input coupled to the combined digital output of the first digital combiner circuit, where the first DAC is adapted to convert the first combined digital data signal to a first analog data signal. A second digital combiner circuit is adapted to combine a plurality of digital data signals and create a second combined digital data signal, and a second digital-to-analog converter (DAC) having an input coupled to the combined digital output of the second digital combiner circuit is adapted to convert the second combined digital data signal to a second analog data signal. The first and second DAC outputs are coupled to an analog combiner circuit adapted to combine the first and second analog data signals to create a combined analog signal, the combined analog signal having a central frequency. An up converter has an input coupled to the output of the analog combiner circuit, wherein the up converter is adapted to shift the central frequency of the combined analog signal in preparation for transmission.

Advantages of the invention include fewer required components in the data transmission device, and reduced noise on the data signals due to combining data signals having adjacent frequency channels.

### BRIEF DESCRIPTION OF THE DRAWINGS

The above features of the present invention will be more clearly understood from consideration of the following descriptions in connection with accompanying drawings in which:

FIG. 1 illustrates a prior art cable interface between a home and headends;

FIG. 2 shows a spectral diagram indicating the frequencies used in the U.S. for a CATV network;

FIG. 3 is a prior art drawing showing a typical headend architecture requiring many components;

FIG. 4 shows a block diagram of the headend of the present invention having digital combiner circuits combining digital signals from two modulators and an analog combiner circuit combining analog signals from a plurality of digital-to-analog converters; and

FIG. 5 shows a block diagram of an alternate embodiment of the present invention, having a digital combiner circuit combining digital signals from a plurality of modulators and a single up converter.

Corresponding numerals and symbols in the different figures refer to corresponding parts unless otherwise indicated.

### DETAILED DESCRIPTION OF PREFERRED EMBODIMENTS

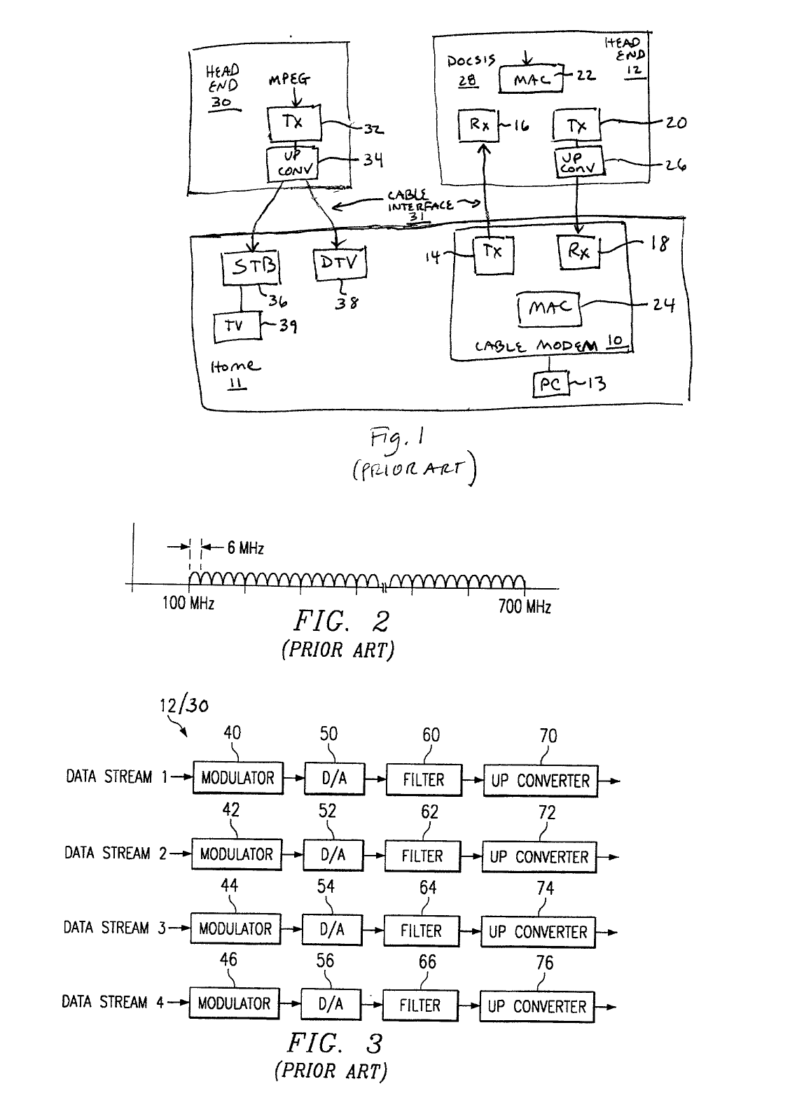

In the United States, the frequency bandwidth used for Cable TV (CATV) transmission is between 100 MHz and 700 MHz, as shown in FIG. 2. Digital transmission of television signals is sent in sets of approximately 6 MHz bandwidth slots, as shown between a headend 12 and a user's cable modem 10 (referring again to FIG. 1). Each signal within a 6 MHz bandwidth slot is unique and contains TV or other data. An up converter 26 is typically used to convert each analog signal up in frequency from less than 100 MHz, for example, to a unique slot in the bandwidth within the range of 88 to 860 MHz, so that approximately 100 analog signals may be transmitted on a single coaxial cable)

FIG. 3 shows a typical CATV headend 12/30 comprising a plurality of modulators 40, 42, 44, 46, with each modulator being adapted to modulate a digital data stream (data stream 1, data stream 2, data stream 3, data stream 4, respectively). Each digital data stream is modulated by a specific modulator 40, 42, 44, 46 that converts the input data stream using a specific modulation scheme, for example, using Quadrature Amplitude Modulation (QAM), which uses both amplitude and phase coding. Each modulator 40, 42, 44, 46 comprises a transmitter and is coupled to a digital-to-analog converter, D/A 50, 52, 54, 56, respectively. D/A's 50, 52, 54, 56 are adapted to convert a digital signal at the input to an analog signal at the output. D/As 50, 52, 54, 56 are each coupled to a respective filter 60, 62, 64, 66, although the filters 60, 62, 64, 66 are optional. An up converter (e.g., mixer) 70, 72, 74, 76 is coupled to each filter 60, 62, 64, 66 as shown. The up converters 70, 72, 74, 76 convert or “move” the analog signal up in frequency to a unique slot within the bandwidth, and the plurality of data streams are combined elsewhere in the system, not shown, prior to transmission to a user at a cable modem 10, for example, via coaxial or HFC cables.

This prior art headend 12/30 architecture is problematic in that it requires many components. A modulator, D/A converter, up converter and possibly a filter are required for each digital data stream. For example, for a headend 12/30 adapted to handle one hundred signals in a CATV network, 100 modulators, D/A's, filters and up converters may be required in the headend 12. Noise may be introduced into the data streams by combining them after up converting the signals.

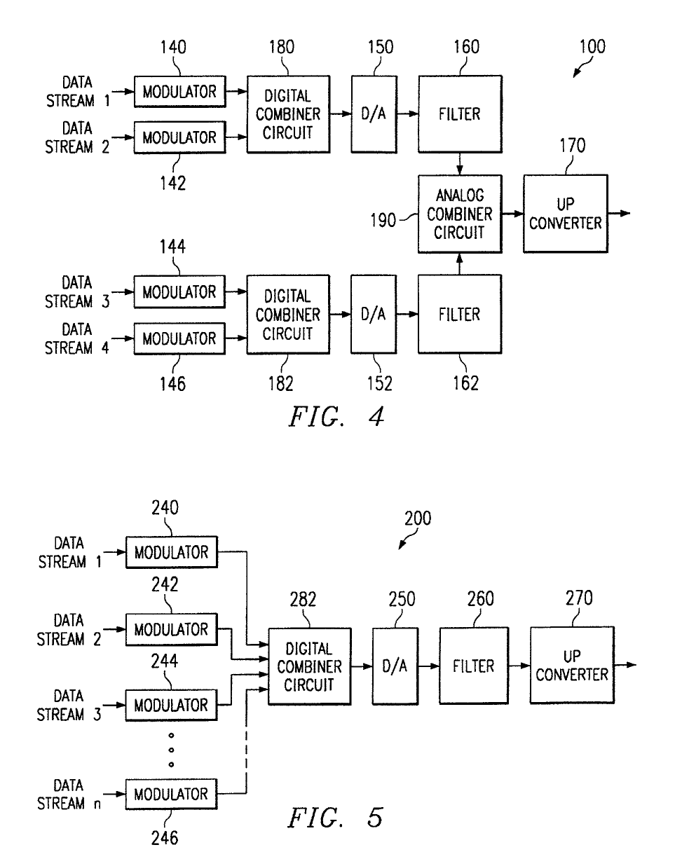

The present invention substantially reduces the number of components in a headend by combining the digital data streams prior to up converting them. FIG. 4 illustrates an exemplary embodiment of the present invention. Data transmission device 100 may comprise a headend, in a CMTS, for example. Digital data streams 1 and 2 are input to a plurality of modulators 140, 142, respectively. Each data stream comprises binary data and contains information in a specific channel that may be encoded. The information in data streams 1 and 2 may comprise MPEG frames that may include DOCSIS data, TV signal, pay-per-view (PPV), and/or Video on Demand, for example.

Modulators 140, 142 receive the digital data streams 1 and 2. Modulators 140, 142 comprise transmitters and are adapted to modulate digital data streams 1 and 2 and produce a modulated data stream at the output. Modulators 140, 142 modulate data streams 1 and 2, respectively, using a modulation scheme such as QAM, for example. The outputs of modulators 140 and 142 are coupled to the inputs of digital combiner circuit 180. Digital combiner circuit 180 preferably comprises a multiplexer adapted to combine modulated data streams 1 and 2 into a single data signal at the output. Alternatively, digital combiner circuit 180 comprises a summer. Digital combiner circuit 180 may be part of the same integrated circuit comprising modulators 140 and 142. The digital combiner circuit 180 summarizes the sequence of digital samples into a single data signal representing the plurality of modulated signals at the input.

The output of digital combiner circuit 180 is input to D/A converter 150. D/A converter 150 is adapted to convert the combined digital signal at the input to an analog signal at the output, allowing the use of fewer D/A converters in the headend 100. Preferably, modulators 140, 142, and D/A 150 comprise a single integrated circuit (IC), although they may comprise separate IC's.

The output of D/A converter 150 is coupled to an optional filter 160 that provides shaping and noise reduction of the analog signal output from the D/A converter 150. Filter 160 preferably comprises an analog low-pass filter (LPF) and may alternatively comprise a capacitor, for example. The output of filter 160 is coupled to an input of analog combiner circuit 190.

Similarly as described for modulators 140 and 142, data streams 3 and 4 are input to modulators 144 and 146, the modulators comprising a transmitter and being adapted to modulate data streams 3 and 4. The output of modulators 144 and 146 are coupled to the inputs of digital combiner circuit 182. Digital combiner circuit 182 is adapted to combine the modulated digital signals from modulators 144 and 146 to create a combined digital signal at the output, allowing the use of fewer D/A converters in the headend 100. The output of digital combiner circuit 182 is coupled to the input of D/A converter 152 which is adapted to convert the combined digital signal to an analog signal. The output of D/A 152 is coupled to an optional filter 162. Filter 162 preferably comprises an analog LPF but may alternatively comprise other filters such as a capacitor. The output of filter 162 is coupled to an input of analog combiner circuit 190 as shown.

Analog combiner circuit 190 is adapted to combine a plurality of analog signals at the input, received from the output of filters 160 and 162, to create a single combined analog signal at the output. Analog combiner circuit 190 preferably comprises a summer that summarizes the two analog signals and verifies that the impedance of each interface will be the same. The analog combiner circuit 190 may comprise a plurality of capacitors and coils, for example, and may include a splitter. Analog combiner circuit 190 allows the use of fewer up converters 170 in the headend 100.

The combined analog signal output from analog combiner circuit 190 is input to the input of up converter 170. Up converter 170 preferably comprises an oscillator that generates the high frequency signals that are required to be added to the input signal. The up converter 170 also includes a function for performing convolution of the two input signals, and a filter for filtering the output signal to verify that it will include the required signals. Up converter 170 converts the information regarding the digital data streams 1, 2, 3 and 4 in the combined analog signal to unique frequencies so that a single combined analog signal may be transmitted from the up converter 170. The output of up converter 170 contains information of all data streams input to the headend 100 and is suitable for transmission within a cable TV network over coaxial and/or HFC cables.

The present invention provides a method of using fewer up converters 170 in a headend 100. Each up converter 170 handles a wider bandwidth for up converting of data streams, preferably in adjacent channels to reduce interference. Therefore, it is preferable, although not required, that the channels of the digital data stream 1 and digital data stream 2 are adjacent. Combining the digital data streams is more effective and noise-reducing than combining the data streams in analog form because digital summing does not cause interference. If the two digital data streams have the same phase, this may also be used to reduce the noise on both signals. Using an algorithm similar to echo canceling, images can be deleted that typically should be in the band of the adjacent channel, synchronizing the signal transmission.

Filters 160 and 162 shown in FIG. 4 are optional. If filters 160 and 162 are not included in the headend 100, the analog combiner circuit 190 combines the signals output from D/A converters 150 and 152.

FIG. 5 shows an alternate embodiment of the present invention, comprising a headend 200 having four or more modulators 240, 242, 244, 246 coupled to the inputs of a digital combiner circuit 282, which output is coupled to a D/A converter 250 as previously described herein. Similarly, eight or more modulators (not shown) may be fed into one digital combiner circuit 282. The more modulators that are coupled to each digital combiner circuit 282, the more components such as D/A's 250, filters 260 and up converters 270 may be eliminated in the headend 200. The analog combiner circuit 190 from FIG. 4 may be eliminated, if all modulators 240, 242, 244, 246 are coupled to a single D/A converter 250, as shown in FIG. 5. However, preferably, four to eight up converters 270 are used within a single headend 200 to up convert approximately a hundred data streams.

In one aspect, the present invention comprises a method of data transmission, comprising generating a plurality of first digital signals, digitally combining at least two of the first digital signals to create a first combined digital signal, and converting the combined first digital signal to a first analog signal having a central frequency. The first analog signal is up converted, e.g., the central frequency of the first analog signal is shifted, to a transmittable analog signal having a frequency suited for transmission along a desired transmission medium, and the transmittable analog signal is transmitted. The data transmission method may also include generating a plurality of second digital signals, digitally combining at least two of the second digital signals to create a second combined digital signal, and converting the combined second digital signal to a second analog signal. The first analog signal and the second analog signal may be combined, and the up converting may include up converting the combined analog signal rather than the first analog signal. Digitally combining the first digital signals may comprise multiplexing the first digital signals, and digitally combining the second digital signals may similarly comprise multiplexing the second digital signals. The first and second digital data signals are preferably modulated before being combined. Optionally, the first analog signal may be filtered after converting it to a first analog signal, and the second analog signal may be filtered after converting it to a second analog signal. The transmission medium may comprise coaxial cable or fiber-optic cable, for example.

The novel circuit and method disclosed herein achieves technical advantages by providing a headend 100/200 requiring fewer components than in the prior art. Fewer D/A converters, filters, and up converters may be used in accordance with the present invention, resulting in cost and space savings. Data streams in adjacent channels may be input to a single D/A converter, resulting in noise reduction on each data stream. Data signals with the same phase particularly benefit from the adjacent channel combination. Because the up converter 170/270 is required to service fewer data signals (100 signals in the prior art versus eight or as few as even one signal in the present invention), the requirements for the up converter 170/270 may be relaxed, resulting in a cost savings. This is particularly advantageous because up converters 170/270 tend to be an expensive component.

Although the invention is described herein for use with data signals via fiberoptic and coaxial cables in a cable TV environment, it is anticipated that the novel concept of using a digital combiner circuit to combine data signals so that a single D/A converter may be used by more than one data signal is effective in other data transmission devices and systems utilizing an up converter such as wireless and satellite applications, for example.

While the invention has been described with reference to illustrative embodiments, this description is not intended to be construed in a limiting sense. Various modifications in combinations of the illustrative embodiments, as well as other embodiments of the invention, will be apparent to persons skilled in the art upon reference to the description. It is therefore intended that the appended claims encompass any such modifications or embodiments.

What is claimed is:

1. A method of data transmission, comprising:
generating a plurality of first digital signals;
digitally combining at least two of the first digital signals to create a first combined digital signal;
converting the first combined digital signal to a first analog signal, the first analog signal having a central frequency; and
shifting the central frequency of the first analog signal to create a transmittable analog signal having a frequency suited for transmission along a desired transmission medium.

2. The method according to claim 1 further comprising:
generating a plurality of second digital signals;
digitally combining at least two of the second digital signals to create a second combined digital signal;
converting the second combined digital signal to a second analog signal; and
combining the first analog signal and the second analog signal to create a combined analog signal having a plurality of central frequencies, wherein shifting the first analog signal central frequency comprises shifting the central frequencies of the combined analog signal.

3. The method according to claim 2 wherein digitally combining at least two of the first digital signals comprises multiplexing the first digital signals, wherein digitally combining at least two of the second digital signals comprises multiplexing the second digital signals.

4. The method according to claim 3 further comprising modulating the first and second digital data signals.

5. The method according to claim 4 further comprising:
filtering the first analog signal after converting to a first analog signal; and
filtering the second analog signal after converting to a second analog signal.

6. The method according to claim 1 wherein the transmission medium comprises coaxial cable or fiber-optic cable.

7. The method according to claim 1 further comprising:
transmitting the transmittable analog signal in a downstream direction.

8. A data transmission device, comprising:
a first digital combiner circuit having a plurality of digital inputs and a combined digital output, the first digital combiner circuit being adapted to combine a plurality of digital data signals and create a first combined digital data signal;
a first digital-to-analog converter (DAC) having an input and an analog output, the first DAC input being coupled to the combined digital output of the first digital combiner circuit, the first DAC being adapted to convert the first combined digital data signal to a first analog data signal; and
an up converter coupled to the first DAC analog output adapted to up convert the first analog data signal in preparation for transmission.

9. The data transmission device according to claim 8, further comprising a plurality of modulators coupled to the first digital combiner circuit for modulating the digital data signals.

10. The data transmission device according to claim 8 wherein the first digital combiner circuit comprises a multiplexer.

11. The data transmission device according to claim 8 further comprising a filter coupled between the first digital-to-analog converter output and an input of the analog combiner circuit.

12. The data transmission device according to claim 8 wherein the first analog data signal has a central frequency, wherein the up converter is adapted to shift the central frequency of the first analog data signal to create a transmittable analog signal having a frequency suited for transmission along a desired transmission medium.

13. The data transmission device according to claim 8 further comprising:
a second digital combiner circuit having a plurality of digital inputs and a combined digital output, the second digital combiner circuit adapted to combine a plurality of digital data signals and create a second combined digital data signal;
a second digital-to-analog converter (DAC) having an input and an analog output, the second DAC input coupled to the combined digital output of the second digital combiner circuit, the second DAC being adapted to convert the second digital data signal to a second analog data signal; and
an analog combiner circuit having a plurality of inputs coupled to the first and second DAC analog outputs, the analog combiner circuit having an output coupled to the input of the up converter, the analog combiner circuit being adapted to combine the first and second analog data signals to create a combined analog signal, wherein the up converter is adapted to up convert the combined analog signal in preparation for transmission.

14. The data transmission device according to claim 13 wherein the analog combiner circuit comprises a summer.

15. The data transmission device according to claim 13 wherein the combined analog signal has a central frequency, wherein the up converter is adapted to shift the central frequency of the combined analog data signal to create a transmittable combined analog signal having a frequency suited for transmission along a desired transmission medium.

16. The data transmission device according to claim 13 further comprising a first filter coupled between the first DAC output and an input of the analog combiner circuit, and a second filter coupled between the second DAC output and an input of the analog combiner circuit.

17. The data transmission device according to claim 8, further comprising a plurality of modulators coupled to the second digital combiner circuit for modulating the digital data signals.

18. The data transmission device according to claim 8, wherein the device comprises a headend of a cable TV network.

19. The data transmission device according to claim 8, wherein the up converter is adapted to generate a transmittable analog data signal, wherein the transmittable analog data signal is transmittable across coaxial cable or fiber-optic cable.

20. A data transmission device, comprising:
a first digital combiner circuit having a plurality of digital inputs and a combined digital output, the first digital combiner circuit being adapted to combine a plurality of digital data signals and create a first combined digital data signal;
a first digital-to-analog converter (DAC) having an input and an analog output, the input being coupled to the combined digital output of the first digital combiner circuit, the first DAC being adapted to convert the first combined digital data signal to a first analog data signal;
a second digital combiner circuit having a plurality of digital inputs and a combined digital output, the second digital combiner circuit being adapted to combine a plurality of digital data signals and create a second combined digital data signal;
a second digital-to-analog converter (DAC) having an input and an analog output, the input being coupled to the combined digital output of the second digital combiner circuit, the second DAC being adapted to convert the second combined digital data signal to a second analog data signal;
an analog combiner circuit having a plurality of inputs and an output, the first DAC output coupled to an input of the analog combiner circuit, the second DAC output coupled to an input of the analog combiner circuit, the analog combiner circuit adapted to combine the first and second analog data signals to create a combined analog signal, the combined analog signal having a central frequency; and
an up converter having an input coupled to the output of the analog combiner circuit, wherein the up converter is adapted to shift the central frequency of the combined analog signal in preparation for transmission.

21. The data transmission device according to claim 20, further comprising a plurality of modulators coupled to the first and second digital combiner circuits for modulating the digital data signals.

22. The data transmission device according to claim 20 wherein the first and second digital combiner circuits comprise multiplexers, wherein the analog combiner circuit comprises a summer.

23. The data transmission device according to claim 20 further comprising filters coupled between the first and second digital-to-analog converter outputs and the analog combiner circuit input.

24. The data transmission device according to claim 20, wherein the device comprises a headend of a cable TV network.

25. The data transmission device according to claim 20 wherein the up converter is adapted to generate a transmittable analog data signal, wherein the transmittable analog data signal is transmittable across coaxial cable or fiber-optic cable.

26. A data transmission device comprising:
means for combining a plurality of digital data signals to create a first combined digital data signal;
means for converting the first combined digital data signal to a first analog data signal, the first analog data signal having a central frequency; and
means for shifting the central frequency of the first analog signal to create a transmittable analog signal having a frequency suited for transmission along a desired transmission medium.

27. The data transmission device according to claim 26, further comprising:
means for combining a plurality of digital data signals to create a second combined digital data signal;
means for converting the second combined digital data signal to a second analog data signal, the second analog data signal having a central frequency; and
means for combining the first and second analog data signals to create a combined analog data signal, wherein the means for shifting the central frequency of the first analog signal is adapted to shift the central frequency of the combined analog data signal to create a transmittable analog signal having a frequency suited for transmission along a desired transmission medium.
